(19) United States
(12) Patent Application Publication
(10) Pub. No.: US 2010/0132260 A1
(43) Pub. Date: Jun. 3, 2010

(54) DOUBLE GLAZING WINDOW HAVING BUILT-IN AUTO CONTROLLING BLINDER

(76) Inventors: Sung Deuk Lee, Gyeonggi-do (KR); Choong Sub Sim, Gangwon-Do (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/452,043

(22) PCT Filed: Sep. 9, 2008
(86) PCT No.: PCT/KR2008/005284

§ 371 Date: Dec. 14, 2009

(30) Foreign Application Priority Data
Sep. 10, 2007 (KR) 10-2007-0091628

(51) Int. Cl. E06B 9/264; E06B 7/00; E06B 9/32

(52) U.S. Cl. 49/70; 160/168.1 P

(57) ABSTRACT

A double glazing window having built in blinder has developed for electrically controlling, which is comprising a control unit (10), an outer frame (20), an inner frame (30), four slim rectangular frame containers between the outer and inner frames, double glazed plate glasses with a closed vacuum space (S), a plurality of blinding strips (50) disposed in the closed vacuum space (S), first operating unit (60) installed in the left frame container, second operating unit (70) connected to the first operating unit (60) for operating by magnetic force, first tilt angle adjusting unit (80) installed in the right frame container, and second tilt angle adjusting unit (90) connected to the first tilt angle adjusting unit (80) for tilting by magnetic force. The sensors are installed for detecting upper and lower limits of an actuator of the operating unit and the tilt angle limit of the actuator of the tilt angle adjusting unit.

### TECHNICAL FIELD

The present invention relates to an electric blind apparatus, and more particularly to an electric blind apparatus built in a multi-layered window, which is automatically manipulated using a unit, such as a remote controller, and prevents an inflow of external moisture and air into a space between glass plates.

### Background Art

In general, blind apparatuses are apparatuses, which are installed on a window and thus intercept sunlight or adjust the amount of sunlight to adjust an indoor atmosphere, prevent the rise in an indoor temperature due to a direct ray of light in a season, when the sun is blazing down, such as summer, and further keep an indoor space from sight to protect private life.

The above blind apparatuses are divided into manual blind apparatuses and automatic blind apparatuses according to methods of controlling slates, serving as sunlight shielding members. In a manual blind apparatus, a user controls the ascent and descent of slates and the angle of the slates by pulling a wire directly, and in an automatic blind apparatus, a user controls the ascent and descent of slates and the angle of the slates using an electric motor to adjust the amount of light.

Recently, many buildings having electric blind apparatuses respectively built in multi-layered windows have been constructed.

In case that a blind apparatus is built in a multi-layered window like this, an indoor space is widened as large as a vertical blind apparatus, which has been generally installed in front of the window, and dust is not accumulated on slates of the blind apparatus and thus the indoor space maintains sanitary conditions all the time.

However, in case that the conventional electric blind apparatus is built in a multi-layered window, external moisture or air flows into a space between glass plates and glass surfaces get misted and thus disturbs a user s sight and causes malfunctions of the electric blind apparatus. When the electric blind apparatus malfunctions, the window needs to be taken off and repaired, and thus a repairing process of the blind apparatus becomes complicated.

### DISCLOSURE OF INVENTION

### Technical Problem

Therefore, the present invention has been made in view of the above problems, and it is an object of the present invention to provide an electric blind apparatus built in a multi-layered window, which prevents an inflow of external moisture and air into a space between glass plates, and automatically adjusts the ascent and descent and the angle of slates with a unit, such as a remote controller.

### Technical Solution

In accordance with an aspect of the present invention, the above and other objects can be accomplished by the provision of an electric blind apparatus built in a multi-layered window, including a control unit; an outer frame unit including upper, lower, left, and right frames, in which the control unit is installed; an inner frame unit including upper, lower, left, and right frames, provided with an outer surface contacting the inner surface of the outer frame unit and glass plates installed on the front and rear surfaces thereof to form a closed space between the inner frame unit and the glass plates; a plurality of slates disposed in the vertical direction in the closed space such that the ascent and descent of the plurality of slates is adjusted by ascent and descent adjusting wires and the angle of the plurality of slates is adjusted by angle adjusting wires wound on a horizontal rotating rod installed in the inner frame unit; a first ascent and descent adjusting unit installed in the left frame of the inner frame unit, and connected to the ascent and descent adjusting wires; a second ascent and descent adjusting unit connected to the first ascent and descent adjusting unit by magnetic force, and ascended and descended by a signal of the control unit to ascend and descend the first ascent and descent adjusting unit; a first angle adjusting unit installed in the right frame of the inner frame unit, and connected to the horizontal rotating rod; and a second angle adjusting unit connected to the first angle adjusting unit by magnetic force, and ascended and descended by a signal of the control unit to rotate the horizontal rotating rod and thus adjust the angle of the slates.

In accordance with another aspect of the present invention, there is provided an electric blind apparatus built in a multi-layered window, including a control unit; an outer frame unit including upper, lower, left, and right frames, in which the control unit is installed; an inner frame unit including upper, lower, left, and right frames, provided with an outer surface contacting the inner surface of the outer frame unit and glass plates installed on the front and rear surfaces thereof to form a closed space between the inner frame unit and the glass plates; a plurality of slates disposed in the vertical direction in the closed space such that the ascent and descent of the plurality of slates is adjusted by ascent and descent adjusting wires and the angle of the plurality of slates is adjusted by angle adjusting wires wound on a horizontal rotating rod installed in the inner frame unit; a first ascent and descent adjusting unit installed in the left frame of the inner frame unit, and connected to the ascent and descent adjusting wires; a second ascent and descent adjusting unit installed in the left frame of the inner frame unit, and ascended and descended by a signal of the control unit; a third ascent and descent adjusting unit disposed on both the upper surface of the left frame of the outer frame unit and the upper surface of the glass plate installed on the front surface of the inner frame unit, and connected to the first ascent and descent adjusting unit and the second ascent and descent adjusting unit by magnetic force to transmit the ascending and descending force of the second ascent and descent adjusting unit to the first ascent and descent adjusting unit and to ascend and descend the first ascent and descent adjusting unit; a first angle adjusting unit installed in the right frame of the inner frame unit, and connected to the horizontal rotating rod; a second angle adjusting unit installed in the right frame of the outer frame unit, and ascended and descended by a signal of the control unit; and a third angle adjusting unit disposed on both the upper surface of the right frame of the outer frame unit and the upper surface of the glass plate installed on the front surface of the inner frame unit, and connected to the first angle adjusting unit and the second angle adjusting unit by magnetic force to transmit the ascending and descending force of the second angle adjusting unit to the first angle adjusting unit to rotate the horizontal rotating rod and thus to adjust the angle of the slates.

### Advantageous Effects

The above-described electric blind apparatus built in a multi-layered window completely prevents an inflow of external moisture and air into a closed space between an inner frame unit and glass plates, thus preventing the formation of substances disturbing a user s sight, such as frost, on the surfaces of the glass plates installed on the front and rear surfaces of the inner frame unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of an electric blind apparatus built in a multi-layered window in accordance with one embodiment of the present invention, seen from one side;

FIG. 2 is a perspective view of the electric blind apparatus in accordance with one embodiment of the present invention, seen from the other side;

FIG. 3 is a view illustrating a second ascent and descent adjusting unit of the electric blind apparatus shown in FIGS. 1 and 2;

FIG. 4 is a view illustrating a first ascent and descent adjusting unit of the electric blind apparatus shown in FIGS. 1 and 2;

FIG. 5 is a view illustrating a first angle adjusting unit and a second angle adjusting unit of the electric blind apparatus shown in FIGS. 1 and 2;

FIG. 6 is a view illustrating a horizontal rotating rod and a vertical rotating rod of the electric blind apparatus shown in FIGS. 1 and 2;

FIGS. 7A and 7B are longitudinal-sectional views of the electric blind apparatus shown in FIGS. 1 and 2;

FIG. 8 is a perspective view of an electric blind apparatus built in a multi-layered window in accordance with another embodiment of the present invention;

FIG. 9 is a longitudinal-sectional view of the electric blind apparatus shown in FIG. 8; and

FIGS. 10A and 10B are transversal-sectional views of the electric blind apparatus shown in FIG. 8.

### BEST MODE FOR CARRYING OUT THE INVENTION

Now, preferred embodiments of the present invention will be described in detail with reference to the annexed drawings.

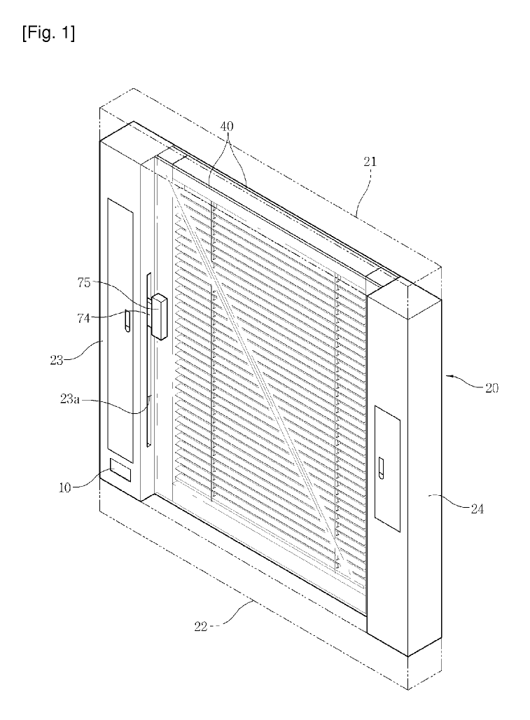

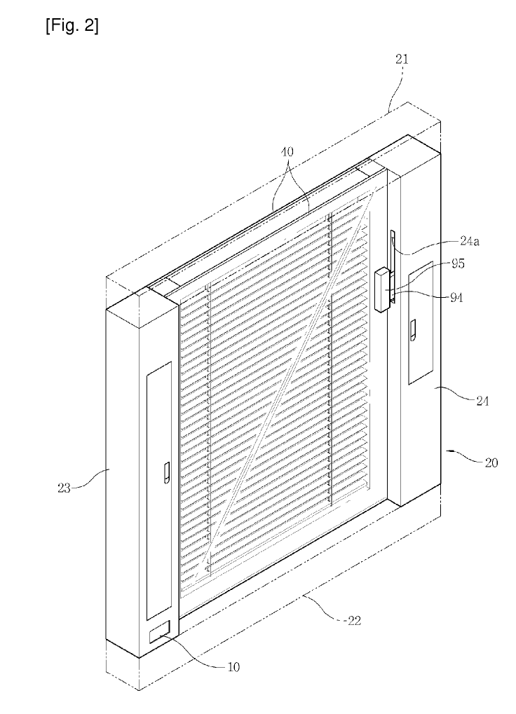

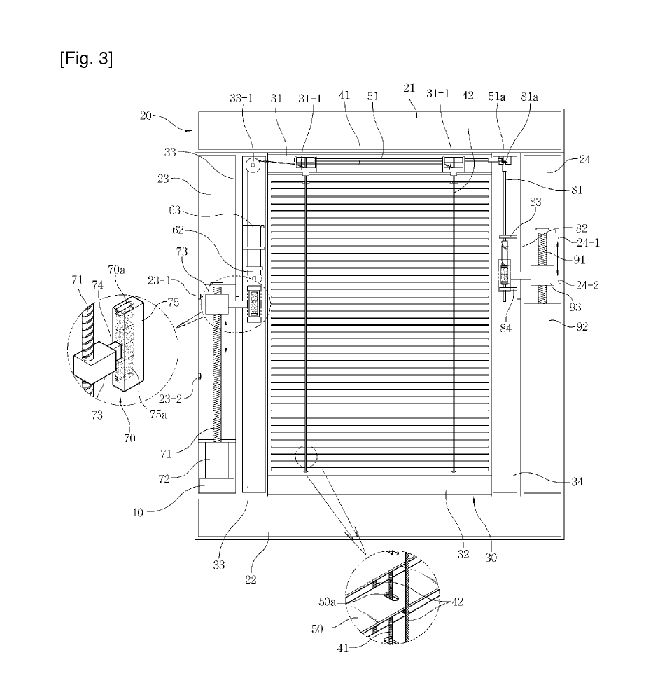

FIG. 1 is a perspective view of an electric blind apparatus built in a multi-layered window in accordance with one embodiment of the present invention, seen from one side, FIG. 2 is a perspective view of the electric blind apparatus in accordance with one embodiment of the present invention, seen from the other side, and FIG. 3 is a view illustrating a second ascent and descent adjusting unit of the electric blind apparatus shown in FIGS. 1 and 2.

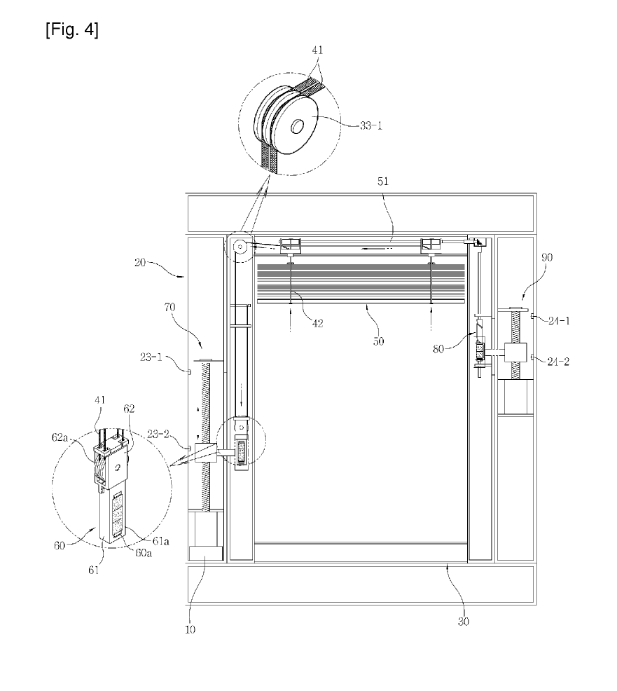

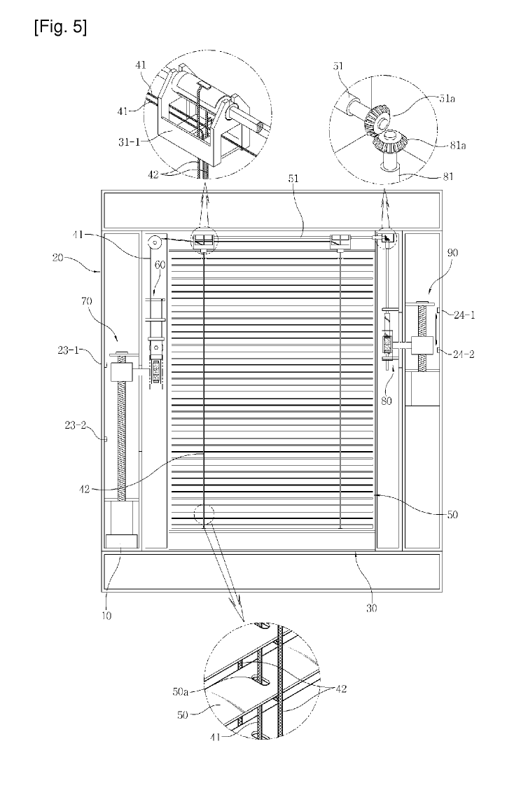

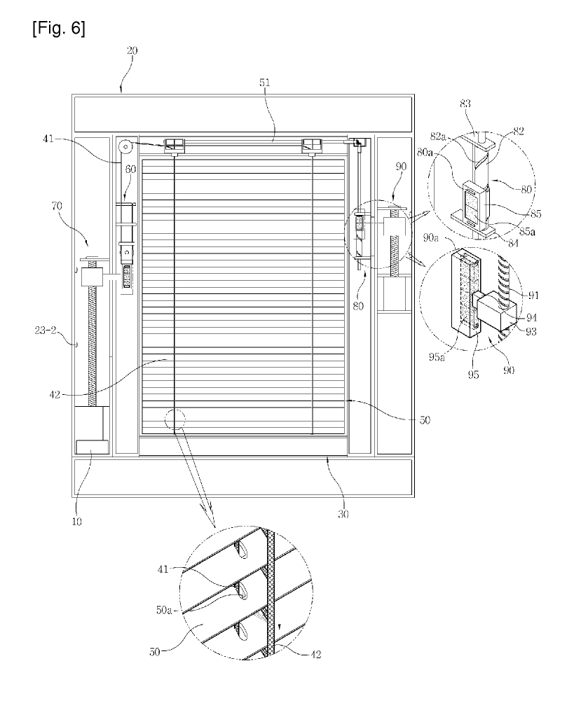

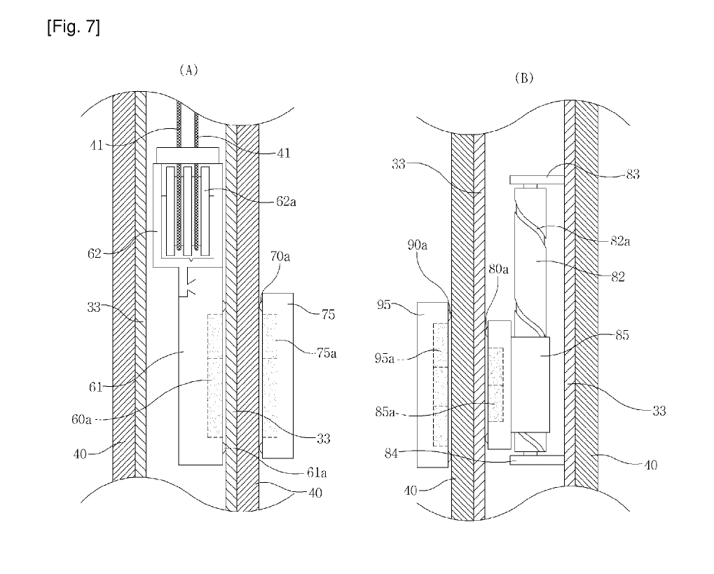

Further, FIG. 4 is a view illustrating a first ascent and descent adjusting unit of the electric blind apparatus shown in FIGS. 1 and 2, FIG. 5 is a view illustrating a first angle adjusting unit and a second angle adjusting unit of the electric blind apparatus shown in FIGS. 1 and 2, FIG. 6 is a view illustrating a horizontal rotating rod and a vertical rotating rod of the electric blind apparatus shown in FIGS. 1 and 2, and FIGS. 7A and 7B are longitudinal-sectional views of the electric blind apparatus shown in FIGS. 1 and 2.

An electric blind apparatus built in a multi-layered window in accordance with one embodiment of the present invention includes a control unit 10 receiving a signal through a remote controller, an outer frame unit 20, in which the control unit 10 is installed, an inner frame unit 30 contacting the inner surface of the outer frame unit 20 and provided with glass plates 40 installed on the front and rear surfaces thereof to form a closed space (S) with the glass plates 40, a plurality of slates 50 installed in the closed space (S) such that the ascent and descent and the angle of the plurality of slates 50 are adjusted by ascent and descent adjusting wires 41 and angle adjusting wires 42, a first ascent and descent adjusting unit 60 installed in the inner frame unit 30 and connected to the ascent and descent adjusting wires 41, a second ascent and descent adjusting unit 70 connected to the first ascent and descent adjusting unit 60 by magnetic force and ascended and descended by the signal of the control unit 10 to ascend and descend the first ascent and descent adjusting unit 60, a first angle adjusting unit 80 installed in the inner frame unit 30 and connected to a horizontal rotating rod 51, and a second angle adjusting unit 90 connected to the first angle adjusting unit 80 by magnetic force and ascended and descended by the signal of the control unit 10 to rotate the horizontal rotating rod 51 and thus adjust the angle of the slates 50.

The outer frame unit 20 has a rectangular frame shape, and includes upper and lower frames 21 and 22 and left and right frames 23 and 24, each having a hollow structure, which are connected to form upper, lower, left, and right sides of the outer frame unit 20. The control unit 10 is installed in the lower end of the left frame 23 of the above outer frame unit 20.

The upper surface of the left frame 23 of the outer frame unit 20 can be opened and closed. Therefore, when the control unit 10 and the second ascent and descent adjusting unit 70 malfunction, the upper surface of the left frame 23 is opened and the control unit 10 and the second ascent and descent adjusting unit 70 are repaired and then are returned to their original positions, and thus the electric blind apparatus of the present invention improves convenience of repair compared with the conventional blind apparatus requiring the removal of the whole window to repair the blind apparatus. More specifically, a rail 23a is formed on one side surface of the left frame 23 of the outer frame unit 20 facing the inner frame unit 30 such that a connector 74 of the second ascent and descent adjusting unit 70, which will be described later, can be ascended and descended along the rail 23a.

Further, the upper surface of the right frame 24 of the outer frame unit 20 can be opened and closed. Therefore, when the second angle adjusting unit 90 malfunctions, the upper surface of the right frame 24 is opened and the second angle adjusting unit 90 is repaired and then is returned to its original position. More specifically, a rail 24a is formed on one side surface of the right frame 24 of the outer frame unit 20 facing the inner frame unit 30 such that a connector 94 of the second angle adjusting unit 90, which will be described later, can be ascended and descended along the rail 24a.

The inner frame unit 30 has a rectangular frame shape, and includes upper and lower frames 31 and 32 and left and right frames 33 and 34, each having a hollow structure, which are connected to form upper, lower, left, and right sides of the inner frame unit 30. The outer surfaces of the upper, lower, left, and right frames 31, 32, 33, and 34 of the inner frame unit 30 contact the inner surfaces of the upper, lower, left, and right frames 21, 22, 23, and 24 of the outer frame unit 20, and the glass plates 40 are respectively installed on the front and rear surfaces of the inner frame unit 30 to form the closed space (S) between the glass plates 40 and the inner frame unit 30.

The outer surfaces of the upper, lower, left, and right frames 31, 32, 33, and 34 of the inner frame unit 30 and the front and rear surfaces of the inner frame unit 30 are properly finish-treated so as to completely seal the closed space (S). Therefore, it is possible to prevent the inflow of external air and moisture into the closed space (S) and the generation of the malfunction of the electric blind apparatus and the formation of substances disturbing a user s sight, such as frost, in the closed space (S) thereby and thus to improve a user s visual field.

The horizontal rotating rod 51 is installed in the upper frame 31 of the inner frame unit 30. The horizontal rotating rod 51 is supported by a plurality of brackets 31-1 installed at a designated interval, and the ascent and descent adjusting wires 41 and the angle adjusting wires 42 pass through the brackets 31-1 and are connected to the slates 50.

Further, a support roller 33-1 is installed in the upper portion of the left frame 33 of the inner frame unit 30, and supports portions of the ascent and descent adjusting wires 41 located between the first ascent and descent adjusting unit 60 and the bracket 31-1.

A plurality of slates 50 is arranged in the vertical direction in the closed space (S) formed by the inner frames 30 and the glass plates 40. The plurality of slates 50 is ascended and descended by the ascent and descent adjusting wires 41, and the angle of the plurality of slates 50 is adjusted by the angle adjusting wires 42 wound on the horizontal rotating rod 51 installed in the upper frame 31 of the inner frame unit 30.

The ascent and descent adjusting wires 41 are continuously inserted into through holes 50a formed through the respective slates 50 and thus ascends and descends the slates 50, and the angle adjusting wires 42 form ladder-shaped spaces, into which the slates 50 are respectively inserted.

The first ascent and descent adjusting unit 60 includes a first ascent and descent magnetic body 61 including magnets 61a facing the glass plate 40 installed on the front surface of the inner frame unit 30, an ascent and descent body 62 installed on the first ascent and descent magnetic body 61 and including a roller 62a, on which the ascent and descent adjusting wires 41 are wound, and a wire fixing piece 63, to which the tips of the ascent and descent adjusting wires 41 are fixed.

The first ascent and descent magnetic body 61 is formed by inserting a plurality of the magnets 61a having a strong magnetic force into a frame made of synthetic resin.

The roller 62a is rotatably installed in the ascent and descent body 62, the ascent and descent adjusting wires 41 are wound on the roller 62a, and the tips of the ascent and descent adjusting wires 41 passed through the roller 62a are fixed to the wire fixing piece 63 installed in the left frame 33 of the inner frame unit 30.

The first ascent and descent adjusting unit 60 is provided with wheels 60a on its contact surface with the glass plate 40 such that the first ascent and descent adjusting unit 60 smoothly moves on the glass plate 40 and does not generate scars on the glass plate 40 during movement.

The second ascent and descent adjusting unit 70 includes a screw shaft 71 installed in the vertical direction in the left frame 23 of the outer frame unit 20, an ascent and descent motor 72 installed at the lower end of the screw shaft 71 and rotated in regular and reverse directions according to the signal of the control unit 10, an ascent and descent nut 73 surrounding the outer circumferential surface of the screw shaft 71 and ascending and descending along the outer circumferential surface of the screw shaft 71 according to the regular and reverse rotations of the ascent and descent motor 72, the connector 74 extended from the outer surface of the ascent and descent nut 73 in the direction of the left frame 33 of the inner frame unit 30, and a second ascent and descent magnetic body 75 connected to the connector 74 and ascended and descended on the upper surface of the glass plate 40 installed on the front surface of the inner frame unit 30 to ascend and descend the first ascent and descent magnetic body 61 by magnetic force.

The screw shaft 71 is provided with a screw formed on the outer circumferential surface thereof, and one end of the screw shaft 71 is connected to the ascent and descent motor 72 and the other end of the screw shaft 71 is rotatably fixed to the inside of the left frame 23 of the outer frame unit 20.

The ascent and descent motor 72 is operated, stopped, or rotated in a regular or reverse direction by the signal supplied from the control unit 10, thus rotating the screw shaft 71 in a regular or reverse direction.

The ascent and descent nut 73 is configured such that it is ascended when the screw shaft 71 is rotated in a regular direction and is descended when the screw shaft 71 is rotated in the reverse direction, or is configured in the opposite manner. That is, the ascent and descent nut 73 converts the rotation of the ascent and descent motor 72 in the horizontal direction into the movement in the vertical direction, and the movement in the vertical direction is transmitted to the second ascent and descent magnetic body 75 through the connector 74.

The second ascent and descent magnetic body 75 is formed by inserting a plurality of magnets 75a having a strong magnetic force into a frame made of synthetic resin, in the same manner as the first ascent and descent magnetic body 61. The second ascent and descent magnetic body 75 is firmly bonded with the first ascent and descent magnetic body 61 by the attractive force between the magnets 75a and the magnets 61a of the first ascent and descent magnetic body 61, although the upper surface of the inner frame unit 30 and the glass plate 40 are disposed between the second ascent and descent magnetic body 75 and the first ascent and descent magnetic body 61.

The second ascent and descent adjusting unit 70 is provided with wheels 70a on its contact surface with the glass plate 40 such that the second ascent and descent adjusting unit 70 smoothly moves on the glass plate 40 and does not generate scars on the glass plate 40 during movement, in the same manner as the first ascent and descent adjusting unit 60.

Hereinafter, the driving process of the first ascent and descent adjusting unit 60 and the second ascent and descent adjusting unit 70 will be described in brief.

When the control unit 10 supplies a signal to the ascent and descent motor 72, the ascent and descent motor 72 is rotated and the screw shaft 71 is rotated in the left frame 33 of the inner frame unit 30 thereby. When the screw shaft 71 is rotated, the ascent and descent nut 73 moves in the vertical direction due to the rotary force of the screw shaft 71, and then simultaneously the connector 74 is ascended and descended in the vertical direction along the rail 23a formed on the left frame 23 of the outer frame unit 20 and the second ascent and descent magnetic body 75 connected to the connector 74 ascends and descends the first ascent and descent magnetic body 61 by magnetic force. Then, the ascent and descent adjusting wires 41 slide the outer circumferential surface of the roller 62a of the ascent and descent body 62, and the slates 50 are moved in the vertical direction thereby.

The first angle adjusting unit 80 includes a vertical rotating rod 81 connected to the horizontal rotating rod 51, a rotating drum 82 surrounding one side of the outer circumferential surface of the vertical rotating rod 81, rotating together with the rotation of the vertical rotating rod 81, and provided with a guide groove 82a formed on the outer circumferential surface thereof, upper and lower fixing pieces 83 and 84 installed in the right frame 34 of the inner frame unit 30, pierced by the vertical rotating rod 81, and respectively connected to the upper and lower ends of the rotating drum 82 to fix the position of the rotating drum 82, and a first angle adjusting magnetic body 85 installed on the outer circumferential surface of the rotating drum 82, including magnets 85a facing the glass plate 40 installed on the front surface of the inner frame unit 30 and a protrusion (not shown) moving along the guide groove 82a of the rotating drum 82, and ascended and descended on the outer circumferential surface of the rotating drum 82.

The vertical rotating rod 81 is made of iron, and one end of the vertical rotating rod 81 is connected to the horizontal rotating rod 51. More specifically, a bevel gear 51a is formed at the right end of the horizontal rotating rod 51 adjacent to the right frame 34 of the inner frame unit 30, a bevel gear 81a engaged with the bevel gear 51a and rotated is formed at the upper end of the vertical rotating rod 81, and thus the rotating force of the vertical rotating rod 81 is transmitted to the horizontal rotating rod 51 and moves the angle adjusting wires 42 to adjust the angle of the slates 50.

The upper and lower fixing pieces 83 and 84, which are respectively formed at the upper and lower ends of the rotating drum 82, are closely adhered to the upper and lower ends of the rotating drum 82 to prevent the vertical movement of the rotating drum 82, and through holes, through which the vertical rotating rod 81 passes, are respectively formed through the upper and lower fixing pieces 83 and 84. Thereby, the vertical rotating rod 81 is rotatably inserted into the through holes of the upper and lower fixing pieces 83 and 84.

The first angle adjusting magnetic body 85 is formed by inserting a plurality of magnets 85a having a strong magnetic force into a frame made of synthetic resin.

The first angle adjusting unit 80 is provided with wheels 80a on its contact surface with the glass plate 40 such that the first angle adjusting unit 80 smoothly moves on the glass plate 40 and does not generate scars on the glass plate 40 during movement.

The second angle adjusting unit 90 includes a screw shaft 91 installed in the right frame 24 of the outer frame unit 20, an angle adjusting motor 92 installed at the lower end of the screw shaft 91 and rotated in regular and reverse directions according to the signal of the control unit 10, an angle adjusting nut 93 surrounding the outer circumferential surface of the screw shaft 91 and ascending and descending along the outer circumferential surface of the screw shaft 91 according to the regular and reverse rotations of the angle adjusting motor 92, the connector 94 extended from the outer surface of the angle adjusting nut 93 in the direction of the right frame 34 of the inner frame unit 30, and a second angle adjusting magnetic body 95 connected to the connector 94 and ascended and descended on the upper surface of the glass plate 40 installed on the front surface of the inner frame unit 30 to ascend and descend the first angle adjusting magnetic body 85 by magnetic force.

The screw shaft 91 is provided with a screw formed on the outer circumferential surface thereof, and one end of the screw shaft 91 is connected to the angle adjusting motor 92 and the other end of the screw shaft 91 is rotatably fixed to the inside of the right frame 24 of the outer frame unit 20. Here, the screw shaft 91 of the second angle adjusting unit 90 is shorter than the screw shaft 71 of the second ascent and descent adjusting unit 70. The reason is that the second angle adjusting magnetic body 95 can vertically move by a shorter distance than the second ascent and descent magnetic body 75 so as to adjust the angle of the slates 50.

The angle adjusting motor 92 is operated, stopped, or rotated in a regular or reverse direction by the signal supplied from the control unit 10, thus rotating the screw shaft 91 in a regular or reverse direction.

The angle adjusting nut 93 is configured such that it is ascended when the screw shaft 91 is rotated in a regular direction and is descended when the screw shaft 91 is rotated in the reverse direction, or is configured in the opposite manner. That is, the angle adjusting nut 93 converts the rotation of the angle adjusting motor 92 in the horizontal direction into the movement in the vertical direction, and the movement in the vertical direction is transmitted to the second angle adjusting magnetic body 95 through the connector 94.

The second angle adjusting magnetic body 95 is formed by inserting a plurality of magnets 95a having a strong magnetic force into a frame made of synthetic resin, in the same manner as the first angle adjusting magnetic body 85. The second angle adjusting magnetic body 95 is firmly bonded with the first angle adjusting magnetic body 85 by the attractive force between the magnets 95a and the magnets 85a of the first angle adjusting magnetic body 85, although the upper surface of the inner frame unit 30 and the glass plate 40 are disposed between the first angle adjusting magnetic body 85 and the second angle adjusting magnetic body 95.

The second angle adjusting unit 90 is provided with wheels 90a on its contact surface with the glass plate 40 such that the second angle adjusting unit 90 smoothly moves on the glass plate 40 and does not generate scars on the glass plate 40 during movement, in the same manner as the first angle adjusting unit 80.

Hereinafter, the driving process of the first angle adjusting unit 80 and the second angle adjusting unit 90 will be described in brief.

When the control unit 10 supplies a signal to the angle adjusting motor 92, the angle adjusting motor 92 is rotated and the screw shaft 91 is rotated in the right frame 34 of the inner frame unit 30 thereby. When the screw shaft 91 is rotated, the angle adjusting nut 93 moves in the vertical direction due to the rotary force of the screw shaft 91, and then simultaneously the connector 94 is ascended and descended in the vertical direction along the rail 24a formed on the right frame 24 of the outer frame unit 20 and the second angle adjusting magnetic body 95 connected to the connector 94 ascends and descends the first angle adjusting magnetic body 85 by magnetic force.

An upper limit sensor 23-1 and a lower limit sensor 23-2, which are respectively sense upper and lower limits of the ascent and descent nut 73, are installed in the left frame 23 of the outer frame unit 20. The upper limit sensor 23-1 and the lower limit sensor 23-2 sense the minimum ascent and descent of the slates 50 in the closed space (S) and transmits the sensed signal to the control unit 10, and the control unit 10 receives the signal and stops the regular or reverse rotation of the ascent and descent motor 72.

Further, an upper limit sensor 24-1 and a lower limit sensor 24-2, which are respectively sense upper and lower limits of the angle adjusting nut 93, are installed in the right frame 24 of the outer frame unit 20. The upper limit sensor 24-1 and the lower limit sensor 24-2 sense that the slates 50 are rotated to the maximum angle to let a sufficient amount of sunlight in or are returned to their original angle to completely shield sunlight and transmits the sensed signal to the control unit 10, and the control unit 10 receives the signal and stops the regular or reverse rotation of the angle adjusting motor 92.

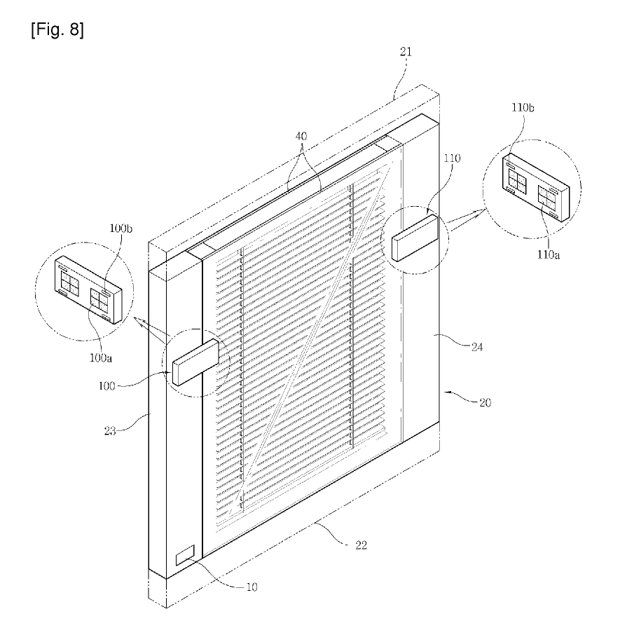

Although this embodiment illustrates the electric blind apparatus built in a multi-layered window with reference to FIGS. 1 to 7, the electric blind apparatus of the present invention is not limited to the structure, as shown in FIGS. 1 to 7, but may have a structure, as shown in FIGS. 8 to 10.

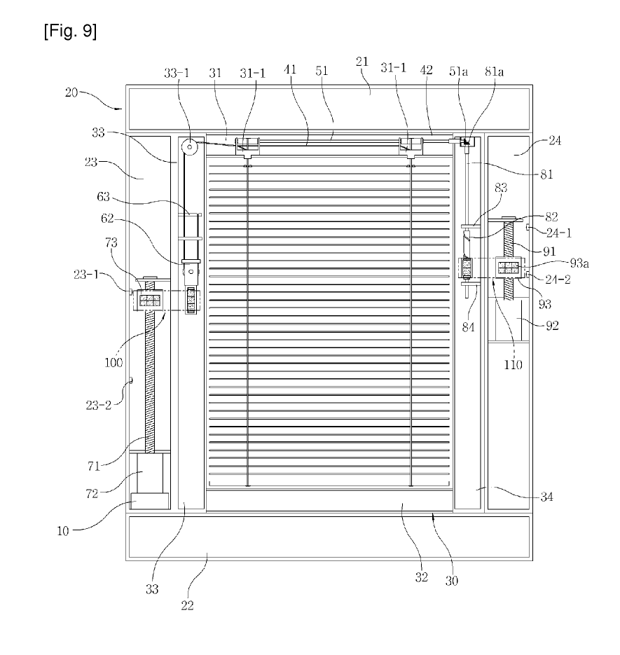

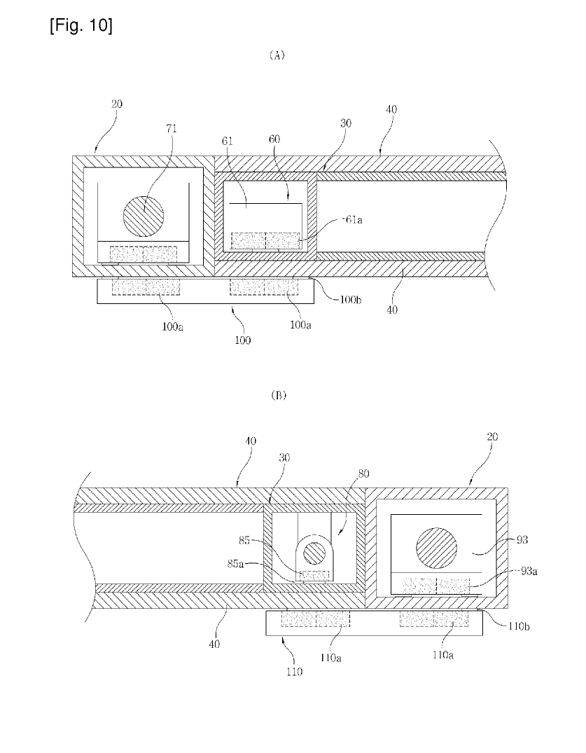

FIG. 8 is a perspective view of an electric blind apparatus built in a multi-layered window in accordance with another embodiment of the present invention, FIG. 9 is a longitudinal-sectional view of the electric blind apparatus shown in FIG. 8, and FIGS. 10A and 10B are transversal-sectional views of the electric blind apparatus shown in FIG. 8.

The configuration of the electric blind apparatus of FIGS. 8 to 10 is the same as that of the electric blind apparatus of FIGS. 1 to 7 except for several elements. Hereinafter, elements of the electric blind apparatus of FIGS. 8 to 10 are stated in brief, and only the several elements of the electric blind apparatus of FIGS. 8 to 10, which differ from those of electric blind apparatus of FIGS. 1 to 7, will be described in detail.

An electric blind apparatus built in a multi-layered window in accordance with another embodiment of the present invention, as shown in FIGS. 8 to 10, includes a control unit 10, an outer frame unit 20 including upper, lower, left, and right frames 21, 22, 23, and 24, in which the control unit 10 is installed, an inner frame unit 30 including upper, lower, left, and right frames 31, 32, 33, and 34, provided with an outer surface contacting the inner surface of the outer frame unit 20 and glass plates 40 installed on the front and rear surfaces thereof to form a closed space (S) with the glass plates 40, a plurality of slates 50 disposed in the vertical direction in the closed space (S) such that the ascent and descent of the plurality of slates 50 is adjusted by ascent and descent adjusting wires 41 and the angle of the plurality of slates 50 is adjusted by angle adjusting wires 42 wound on a horizontal rotating rod 51 installed in the inner frame unit 30, a first ascent and descent adjusting unit 60 installed in the left frame 33 of the inner frame unit 30 and connected to the ascent and descent adjusting wires 41, a second ascent and descent adjusting unit 70 installed in the left frame 33 of the inner frame unit 30 and ascended and descended by a signal of the control unit 10, a third ascent and descent adjusting unit 100 disposed on both the upper surface of the left frame 23 of the outer frame unit 20 and the upper surface of the glass plate 40 installed on the front surface of the inner frame unit 30 and connected to the first ascent and descent adjusting unit 60 and the second ascent and descent adjusting unit 70 by magnetic force to transmit the ascending and descending force of the second ascent and descent adjusting unit 70 to the first ascent and descent adjusting unit 60 to ascend and descend the first ascent and descent adjusting unit 60, a first angle adjusting unit 80 installed in the right frame 34 of the inner frame unit 30 and connected to the horizontal rotating rod 51, a second angle adjusting unit 90 installed in the right frame 24 of the outer frame unit 20 and ascended and descended by the signal of the control unit 10, and a third angle adjusting unit 110 disposed on both the upper surface of the right frame 24 of the outer frame unit 20 and the upper surface of the glass plate 40 installed on the front surface of the inner frame unit 30 and connected to the first angle adjusting unit 80 and the second angle adjusting unit 90 by magnetic force to transmit the ascending and descending force of the second angle adjusting unit 90 to the first angle adjusting unit 80 to rotate the horizontal rotating rod 51 and thus to adjust the angle of the slates 50.

The first ascent and descent adjusting unit 60 includes a first ascent and descent magnetic body 61 including magnets 61a facing the glass plate 40 installed on the front surface of the inner frame unit 30, an ascent and descent body 62 installed on the first ascent and descent magnetic body 61 and including a roller 62a, on which the ascent and descent adjusting wires 41 are wound, and a wire fixing piece 63, to which the tips of the ascent and descent adjusting wires 41 are fixed.

The second ascent and descent adjusting unit 70 includes a screw shaft 71 installed in the vertical direction in the left frame 23 of the outer frame unit 20, an ascent and descent motor 72 installed at the lower end of the screw shaft 71 and rotated in regular and reverse directions according to the signal of the control unit 10, an ascent and descent nut 73 surrounding the outer circumferential surface of the screw shaft 71 and ascending and descending along the outer circumferential surface of the screw shaft 71 according to the regular and reverse rotations of the ascent and descent motor 72, and a second ascent and descent magnetic body 75 formed integrally with the ascent and descent nut 73 and ascended and descended on the lower surface of the left frame 33 of the inner frame unit 30.

The third ascent and descent adjusting unit 100 includes magnets 100a facing the upper surface of the left frame 23 of the outer frame unit 20 and the upper surface of the glass plate 40 installed on the front surface of the inner frame unit 30 such that the third ascent and descent adjusting unit 100 can be connected to the first ascent and descent magnetic body 61 and the second ascent and descent magnet body 75 by magnetic force.

The first angle adjusting unit 80 includes a vertical rotating rod 81 connected to the horizontal rotating rod 51, a rotating drum 82 surrounding one side of the outer circumferential surface of the vertical rotating rod 81, rotating together with the rotation of the vertical rotating rod 81, and provided with a guide groove 82a formed on the outer circumferential surface thereof, upper and lower fixing pieces 83 and 84 installed in the right frame 34 of the inner frame unit 30, pierced by the vertical rotating rod 81, and respectively connected to the upper and lower ends of the rotating drum 82 to fix the position of the rotating drum 82, and a first angle adjusting magnetic body 85 installed on the outer circumferential surface of the rotating drum 82, including magnets 85a facing the glass plate 40 installed on the front surface of the inner frame unit 30 and a protrusion (not shown) moving along the guide groove 82a of the rotating drum 82, and ascended and descended on the outer circumferential surface of the rotating drum 82.

The second angle adjusting unit 90 includes a screw shaft 91 installed in the right frame 24 of the outer frame unit 20, an angle adjusting motor 92 installed at the lower end of the screw shaft 91 and rotated in regular and reverse directions according to the signal of the control unit 10, an angle adjusting nut 93 surrounding the outer circumferential surface of the screw shaft 91 and ascending and descending along the outer circumferential surface of the screw shaft 91 according to the regular and reverse rotations of the angle adjusting motor 92, and a second angle adjusting magnetic body 95 formed integrally with the angle adjusting nut 93 and ascended and descended on the lower surface of the right frame 34 of the inner frame unit 30.

The third angle adjusting unit 110 includes magnets 110a facing the upper surface of the right frame 24 of the outer frame unit 20 and the upper surface of the glass plate 40 installed on the front surface of the inner frame unit 30 such that the third angle adjusting unit 110 can be connected to the first angle adjusting magnetic body 85 and the second angle adjusting magnetic body 95 by magnetic force.

Hereinafter, differences between the electric blind apparatus shown in FIGS. 1 to 7 and the electric blind apparatus shown in FIGS. 8 to 10 will be described. First, in the electric blind apparatus shown in FIGS. 1 to 7, in order to ascend and descend the slates 50, the magnets 61a of the first ascent and descent magnetic body 61 and the magnets 75a of the second ascent and descent magnetic body 75 face each other, and are connected by magnetic force. On the other hand, in the electric blind apparatus shown in FIGS. 8 to 10, in order to ascend and descend the slates 50, the second ascent and descent adjusting unit 70 is completely installed in the left frame 23 of the outer frame unit 20 and the magnets 61a of the first ascent and descent magnetic body 61 and the magnets 75a of the second ascent and descent magnetic body 75 face in the same direction, more specifically, the magnets 61a of the first ascent and descent magnetic body 61 installed in the left frame 33 of the inner frame unit 30 face the upper surface of the left frame 33 of the inner frame unit 30, and the magnets 75a of the second ascent and descent magnetic body 75 installed in the left frame 23 of the outer frame unit 20 face the upper surface of the left frame 23 of the outer frame unit 20. Thereafter, the third ascent and descent adjusting unit 100 is installed on both the upper surface of the left frame 23 of the outer frame unit 20 and the upper surface of the glass plate 40 installed on the front surface of the inner frame unit 30, is connected to the first ascent and descent adjusting unit 60 and the second ascent and descent adjusting unit 70 by magnetic force, and transmits the ascending and descending force of the second ascent and descent adjusting unit 70 to the first ascent and descent adjusting unit 60 to move the first ascent and descent adjusting unit 60 vertically and thus to ascend and descend the slates 50.

The third ascent and descent adjusting unit 100 is formed by inserting a plurality of the magnets 100a having a strong magnetic force into a frame made of synthetic resin, and is provided with wheels 100b such that the third ascent and descent adjusting unit 100 does not generate scars on the outer frame unit 20 and the glass plate 40 during movement. Here, the magnets 100a of the third ascent and descent adjusting unit 100 face the magnets 61a of the first ascent and descent magnetic body 61 and the magnets 75a of the second ascent and descent magnetic body 75, and thus are firmly bonded to the magnets 61a and the magnets 75a by the attractive force therebetween.

Further, in the electric blind apparatus shown in FIGS. 1 to 7, in order to ascend and descend the slates 50, the rail 23a is formed on one side surface of the left frame 23 of the outer frame unit 20 and the connector 74 of the second ascent and descent adjusting unit 70 moves along the rail 23a to ascend and descend the first ascent and descent adjusting unit 60. On the other hand, in the electric blind apparatus shown in FIGS. 8 to 10, the third ascent and descent adjusting unit 100 transmits the ascending and descending force of the second ascent and descent adjusting unit 70 to the first ascent and descent adjusting unit 60, and thus the electric blind apparatus shown in FIGS. 8 to 10 does not require the connector 74 of the second ascent and descent adjusting unit 70 and the rail 23a formed on the left frame 23 of the outer frame unit 20, as shown in FIGS. 1 to 7.

Moreover, in the electric blind apparatus shown in FIGS. 1 to 7, in order to adjust the angle of the slates 50, the magnets 85a of the first angle adjusting magnetic body 85 and the magnets 95a of the second angle adjusting magnetic body 95 face each other, and are connected by magnetic force. On the other hand, in the electric blind apparatus shown in FIGS. 8 to 10, in order to adjust the angle of the slates 50, the second angle adjusting unit 90 is completely installed in the right frame 24 of the outer frame unit 20 and the magnets 85a of the first angle adjusting magnetic body 85 and the magnets 95a of the second angle adjusting magnetic body 95 face in the same direction, more specifically, the magnets 85a of the first angle adjusting magnetic body 85 installed in the right frame 34 of the inner frame unit 30 face the upper surface of the right frame 34 of the inner frame unit 30, and the magnets 95a of the second angle adjusting magnetic body 95 installed in the right frame 24 of the outer frame unit 20 face the upper surface of the right frame 24 of the outer frame unit 20. Thereafter, the third angle adjusting unit 100 is installed on both the upper surface of the right frame 24 of the outer frame unit 20 and the upper surface of the glass plate 40 installed on the front surface of the inner frame unit 30, is connected to the first angle adjusting unit 80 and the second angle adjusting unit 90 by magnetic force, and transmits the ascending and descending force of the second angle adjusting unit 90 to the first angle adjusting unit 80 to rotate the vertical rotating rod 81 of the first angle adjusting unit 80 and the horizontal rotating rod 51 connected to the vertical rotating rod 81 and thus to adjust the angle of the slates 50 by the angle adjusting wires 42 wound on the horizontal rotating rod 51.

The third angle adjusting unit 110 is formed by inserting a plurality of the magnets 110a having a strong magnetic force into a frame made of synthetic resin, and is provided with wheels 110b such that the third angle adjusting unit 110 does not generate scars on the outer frame unit 20 and the glass plate 40 during movement. Here, the magnets 110a of the third angle adjusting unit 110 face the magnets 85a of the first angle adjusting magnetic body 85 and the magnets 95a of the second angle adjusting magnetic body 95, and thus are firmly bonded to the magnets 85a and the magnets 95a by the attractive force therebetween.

Further, in the electric blind apparatus shown in FIGS. 1 to 7, in order to adjust the angle of the slates 50, the rail 24a is formed on one side surface of the right frame 24 of the outer frame unit 20 and the connector 94 of the second angle adjusting unit 90 moves along the rail 24a to ascend and descend the first angle adjusting unit 90. On the other hand, in the electric blind apparatus shown in FIGS. 8 to 10, the third angle adjusting unit 110 transmits the ascending and descending force of the second angle adjusting unit 90 to the first angle adjusting unit 80, and thus the electric blind apparatus shown in FIGS. 8 to 10 does not require the connector 94 of the second angle adjusting unit 90 and the rail 24a formed on the right frame 24 of the outer frame unit 20, as shown in FIGS. 1 to 7.

Except for the above-described differences, the electric blind apparatus shown in FIGS. 8 to 10 has the same configuration as that of the electric blind apparatus shown in FIGS. 1 to 7. That is, the configuration of the electric blind apparatus shown in FIGS. 8 to 10 is the same as that of the electric blind apparatus shown in FIGS. 1 to 7 in that the upper surfaces of the left frame 23 and the right frame 24 of the outer frame unit 20 can be opened and closed, the upper limit sensor 23-1 and the lower limit sensor 23-2 to sense upper and lower limits of the ascent and descent nut 73 are installed in the left frame 23 of the outer frame unit 20, the upper limit sensor 24-1 and the lower limit sensor 24-2 to sense upper and lower limits of the angle adjusting nut 93 are installed in the right frame 24 of the outer frame unit 20, and the horizontal rotating rod 51 and the vertical rotating rod 81 are connected by the bevel gears 51a and 81a.

### INDUSTRIAL APPLICABILITY

The electric blind apparatus built in a multi-layered window in accordance with the present invention completely prevents an inflow of external moisture and air into a closed space between an inner frame unit and glass plates, thus preventing the formation of substances disturbing a user s sight, such as frost, on the surfaces of the glass plates installed on the front and rear surfaces of the inner frame unit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1-12. (canceled)

13. A double glazing window having built-in blinder, which is electrically operating and controlling, said the window comprising:
a control unit for operating and tilting the blinder,
an outer frame unit having a rectangular shape,
an inner frame unit having the rectangular shape, which is smaller than the outer frame unit,
a set of frame containers forming slim rectangular-shapes around upper, lower, left, and right sides between the outer frame and the inner frame for installing operational units,
a set of double glazed plate glasses installed on front and rear surfaces of the inner frame unit to form a closed vacuum space,
a plurality of blinder strips vertically disposed in the closed vacuum space, so that the blinder strips are operated for ascending or descending by winding operating strings and tilt angle of the blinder strips being adjusted by tilt-angle adjusting strings on a pulley installed on rotating rods,
first operating unit connected to the operating strings for ascending or descending the blinder and installed in the left frame container,
second operating unit connected to the first operating unit through the plate glasses for operating to ascending or descending the blinder by magnetic force according to a signal of the control unit to the first operating unit,
first tilt angle adjusting unit connected to a rotating rod and installed in the right side frame container, and
second tilt angle adjusting unit connected to the first tilt angle adjusting unit through the plate glasses for tilting the blinder by magnetic force according to the signal of the control unit.

14. The double glazing window having built-in blinder according to claim 13, wherein
the first operating unit further comprising first magnetic body including magnets facing to the plate glass installed on the front surface of the inner frame unit, an operating body installed on the first magnetic body, a pulley for winding the operating strings, and a pair of fixtures for mounting the pulley,
the second operating unit further comprising a screw shaft vertically disposed inside the left frame container, an operating motor installed at lower end of the screw shaft for rotating forward or reverse direction according to the signal of the control unit, an operating actuator mounting on the screw shaft for ascending or descending along the screw shaft, a connector extended from the operating actuator to the left frame container, and second magnetic body connected to the first magnetic body through the plate glass for operating by magnetic force, and
a set of sensors installed in the left frame container for detecting upper and lower limits of the actuator for ascending and descending operation.

15. The double glazing window having built-in blinder according to claim 13, wherein
the first tilt angle adjusting unit further comprising a vertical rotating rod connected to a horizontal rotating rod, a set of bevel gears installed to each end of the horizontal rotating rod and the vertical rotating rod to be perpendicularly engaged each other for transmitting rotational force, a rotating drum mounted at lower end of the vertical rotating rod, and a guide groove formed spirally on a circumferential surface of the rotating drum, a set of upper and lower fixtures attached inside the right frame container for mounting the rotating drum between the upper and lower fixtures, and first tilt angle adjusting magnetic body with magnets attached on the rotating drum for traveling through the spiral guide groove of the rotating drum, the magnets facing to the plate glass and a pair of small rollers for rolling over the plate glass according to the ascending or descending of the rotating drum,
the second tilt angle adjusting unit further comprising a screw shaft disposed inside the right frame container, a tilt angle adjusting motor installed at the lower end of the screw shaft for rotating forward or reverse direction according to a signal of the control unit, a tilt angle adjusting actuator mounting on the screw shaft for traveling along the screw shaft, a connector extended from the tilt angle adjusting actuator through the right frame container for connecting to second tilt angle adjusting magnetic body, so that the first tilt angle adjusting magnetic body is faced to the second tilt angle adjusting magnetic body through the plate glass for transmitting the tilting actuation by the magnetic force, and
a set of sensors installed in the right frame container for detecting the tilt angle limits of the tilt angle adjusting actuator.

16. The double glazing window having built-in blinder according to claim 14, wherein the left frame container has an open-able door and forms a long slot at inside lateral surface thereof, so that the connector extended from the operating actuator is able to travel alone with the long slot.

17. The double glazing window having built-in blinder according to claim 15, wherein the right frame container has an open-able door and forms a short slot at inside lateral surface thereof, so that the connector extended from the second angle adjusting actuator is able to travel alone with the short slot.

18. A double glazing window having built-in blinder, which is electrically operating and controlling, said the window comprising:
a control unit for operating and controlling the blinder,
an outer frame unit having a rectangular shape,
an inner frame unit having the rectangular shape, which is smaller than the outer frame unit,
a set of frame containers forming slim rectangular-shapes around upper, lower, left, and right sides between the outer frame and the inner frame for installing operational units,
a set of double glazed plate glasses installed on front and rear surfaces of the inner frame unit to form a closed vacuum space,
a plurality of blinder strips vertically disposed in the closed vacuum space, so that the blinder strips are operated for ascending or descending by winding operating strings and tilt angle of the blinder strips being adjusted by tilt-angle adjusting strings on a pulley installed on rotating rods,
first operating unit connected to operating strings for ascending or descending the blinder and installed in the left frame container,
second operating unit installed in the left frame container and faced to the plate glasses for ascending or descending the blinder by magnetic force, according to a signal of the control unit,
third operating unit disposing over the first operating unit and second operating unit for contacting front surfaces one another, through the plate glass to ascend or descend the blinder by magnetic force, which is transmitted from the first, third to the second operating units, according to the control unit signal,
first tilt angle adjusting unit connected to a rotating rod and installed in the right side frame container,
second tilt angle adjusting unit installed in the left frame container and faced to the plate glasses for ascending or descending the blinder by magnetic force, according to the control unit signal, and
third tilt angle adjusting unit disposing over the first and second tilt angle adjusting units for contacting the front surfaces one another, through the plate glass to ascend or descend the blinder by magnetic force, which is transmitted from the first, third to the second tilt angle adjusting units according to the control unit signal.

19. The double glazing window having built-in blinder according to claim 18, wherein
the first operating unit further comprising first magnetic body including magnets facing to the plate glass installed on the front surface of the inner frame unit, an operating body installed on the first magnetic body, a pulley for winding the operating strings, and a pair of fixtures for mounting the pulley,
the second operating unit further comprising a screw shaft vertically disposed inside the left frame container, an operating motor installed at lower end of the screw shaft for rotating forward or reverse direction according to the signal of the control unit, an operating actuator mounting on the screw shaft for ascending or descending along the screw shaft, a connector extended from the operating actuator to the left frame container, and second magnetic body integrally formed with the operating actuator in the lower surface of the left frame container for operating by magnetic force, and
the third operating unit further comprising magnets facing to the first operating unit and second operating unit through the plate glass installed on the front surface of the inner frame unit, so that the third operating unit can be transmitted ascending and descending operations to the first and second magnetic bodies by the magnetic force, and
a set of sensors installed in the left frame container for detecting upper and lower limits of the operating actuator for ascending and descending operation.

20. The double glazing window having built-in blinder according to claim 18, wherein
the first tilt angle adjusting unit further comprises a vertical rotating rod connected to a horizontal rotating rod, a set of bevel gears installed to each end of the horizontal rotating rod and the vertical rotating rod to be perpendicularly engaged each other for transmitting rotational force, a rotating drum mounted at lower end of the vertical rotating rod, and a guide groove formed spirally on a circumferential surface of the rotating drum, a set of upper and lower fixtures installed inside the right frame container for mounting the rotating drum between the upper and lower fixtures, and first tilt angle adjusting magnetic body with magnets attached on the rotating drum for traveling through the spiral guide groove of the rotating drum, the magnets facing to the plate glass and a pair of small rollers for rolling over the plate glass according to the ascending or descending of the rotating drum,
the second tilt angle adjusting unit further comprising a screw shaft disposed inside the right frame container, a tilt angle adjusting motor installed at the lower end of the screw shaft for rotating forward or reverse direction according to a signal of the control unit, a tilt angle adjusting actuator mounting on the screw shaft for traveling along the screw shaft, a connector extended from the tilt angle adjusting actuator to the left frame container, and second tilt angle adjusting magnetic body integrally formed with the tilt angle adjusting actuator in the lower surface of the right frame container for tilting operation by magnetic force,
the third tilt angle adjusting unit further comprising magnets facing to the first and second tilt angle adjusting units through the plate glass installed on the front surface of the inner frame unit, so that the third tilt angle adjusting unit is able to transmit the tilt adjusting to the first and second tilt angle adjusting magnetic bodies by the magnetic force,
a set of open-able doors installed at both left and right frame containers, and
a set of sensors installed in the right frame container for detecting tilt angle limits of the tilt angle adjusting actuator.
